(19) United States
(12) Patent Application Publication
(10) Pub. No.: US 2007/0132118 A1
(43) Pub. Date: Jun. 14, 2007

(54) Method and Apparatus for Treatment of a Device-in-Mold Assembly with a Supercritical Fluid

(75) Inventors: Wen Jin, Victor, NY (US); Larry C. Hovey, Ontario, NY (US); Sandeep Pandit, Rochester, NY (US); Sanjay Rastogi, Rochester, NY (US)

Correspondence Address: Bausch & Lomb Incorporated, One Bausch & Lomb Place, Rochester, NY, 14604-2701, US

(73) Assignee: BAUSCH AND LOMB INCORPORATED, Rochester, NY (US)

(21) Appl. No.: 11/164,902

(22) Filed: Dec. 9, 2005

(51) Int. Cl. B29D 11/00

(52) U.S. Cl. 264/1.1; 264/85; 425/808; 425/253; 425/413; 425/405.1

(57) ABSTRACT

An apparatus for locating and retaining a plurality of device-in-mold assemblies within a supercritical fluid chamber, wherein at least one of residual extraction or release occurs within the chamber. The apparatus can include a plurality of trays for receiving the plurality of device-in-mold assemblies, the trays being sufficiently spaced for non interfering transition of the device-in-mold assemblies from a molded state to a released state.

### FIELD OF THE INVENTION

The present invention relates to methods of manufacturing or processing ophthalmic devices, and more particularly, to exposing ophthalmic device-in-mold assemblies to a supercritical fluid.

### DESCRIPTION OF RELATED ART

Polymerized contact lens materials must not only have sufficient optical clarity, but also must be suitable for contact with the eye for extended periods. Contact lenses made from such materials must be sufficiently hydrophilic at the lens surface to properly “wet.” Wetting is the characteristic understood to relate to the ability of the contact lens to be lubricated by natural tears in the eye so that the lens can move freely over the eye in use. This freedom of movement over the eye keeps the lens from adhering to the eye and allows a continuous stream of tears to wash under and over the lens resulting in enhanced comfort.

Large-scale manufacturing processes require disposal of relatively high volumes of extraction solutions used to remove impurities and residual materials (sometimes referred to as residuals or extractables) from the lenses. In addition, various materials used as solvents provide potentially hazardous conditions to working environments due to material toxicity to humans or flammability, for example.

Treatment of ophthalmic devices with a supercritical fluid has been found advantageous. However, the need remains for an apparatus and method for efficiently treating a number of ophthalmic devices with a supercritical fluid.

### BRIEF SUMMARY OF THE INVENTION

The present invention provides an apparatus and method for exposing ophthalmic device-in-mold assemblies to a supercritical fluid environment, wherein the supercritical fluid can be used to extract residuals from the device and release the device from the mold.

In one configuration, the apparatus for treating an ophthalmic device-in-mold assembly includes a supercritical fluid chamber; a tray within the supercritical fluid chamber, the tray having at least one retaining socket; and an ophthalmic device-in-mold assembly at least partially retained within the socket. In one configuration, the ophthalmic device-in-mold assembly includes a lens defining surface.

A method is also provided for treating an ophthalmic device-in-mold assembly wherein the method includes locating the ophthalmic device-in-mold assembly on a tray in a supercritical fluid treatment chamber. In a particular configuration, the method includes retaining the ophthalmic device-in-mold assembly on a tray and disposing the tray and the retained ophthalmic device-in-mold assembly in a supercritical fluid treatment chamber.

The present method further allows for disposing a plurality of trays in the supercritical fluid chamber as well as spacing the trays by a sufficient distance to permit and enhance transitioning of the device-in-mold assembly from a molded configuration to a released configuration.

Although the associated mold assembly includes a pair of optical surface forming mold surfaces, the mold assembly is typically separated before entering the supercritical fluid chamber. By separating the mold sections before entering the supercritical fluid chamber, the ophthalmic device-in-mold assembly in the chamber includes only a single optical surface forming mold surface.

### BRIEF DESCRIPTION OF THE SEVERAL VIEWS OF THE DRAWING(S)

FIG. 1 is a cross-sectional view of a joined mold assembly with a retained dose of monomer.

FIG. 2 is an exploded view of a contact lens and mold assembly.

FIG. 3 is a partial cross-sectional view of a plurality of device-in-mold assemblies within a supercritical fluid chamber.

FIG. 4 is a cross-sectional view of a device-in-mold assembly in a molded state.

FIG. 5 is a cross-sectional view of a device-in-mold assembly in a representative released state.

FIG. 6 is a perspective view of a tray.

FIG. 7 is a perspective view of a spacing mechanism.

FIG. 8 is a perspective view of a plurality of trays on a spindle.

### DETAILED DESCRIPTION OF THE INVENTION

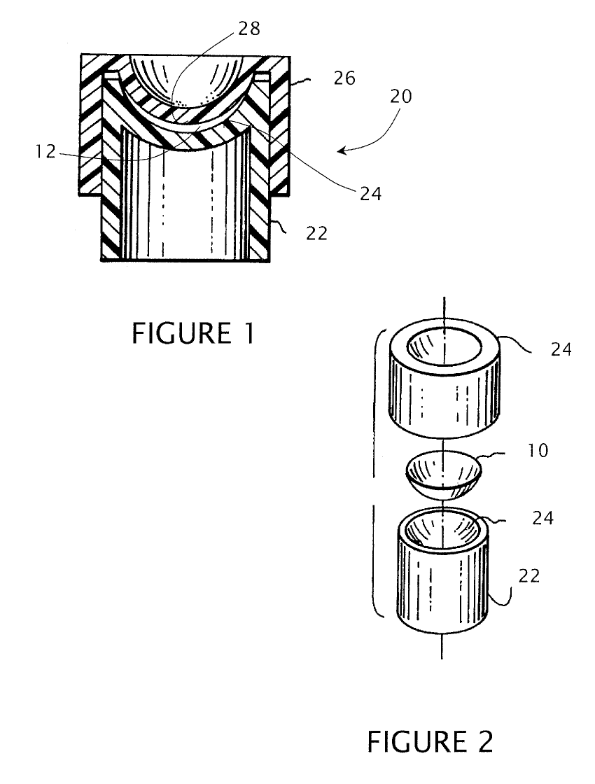

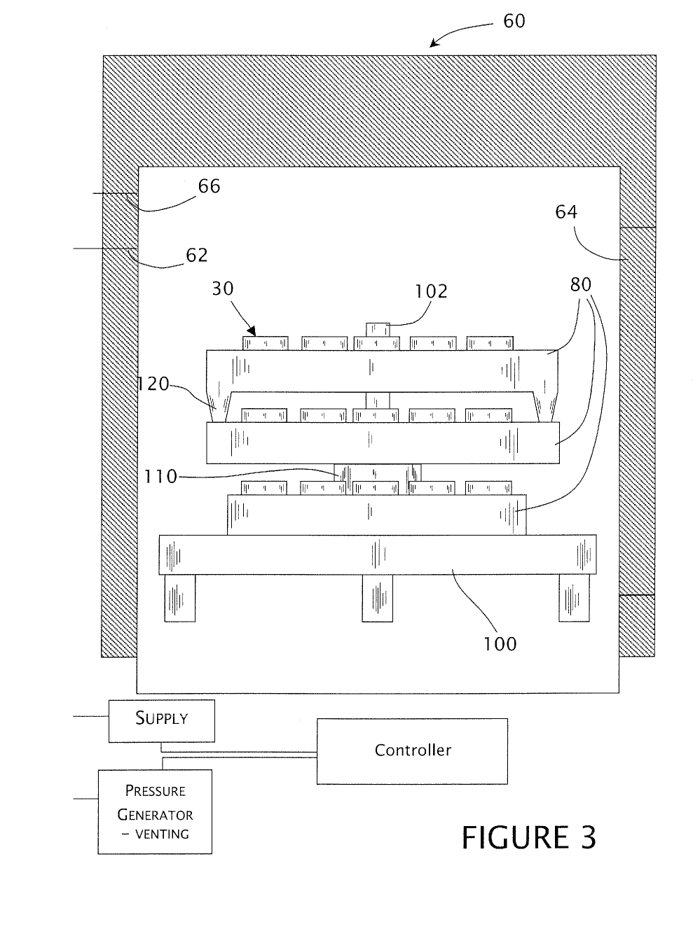

Generally, the present invention relates to the formation of an ophthalmic device, such as a contact lens 10. Referring to FIGS. 1 and 2, the contact lens 10 is formed by curing a monomer 12 in a mold assembly 20. As more fully set forth below, the mold assembly 20 includes an anterior section 22 and a posterior section 26, wherein after curing of the monomer in the mold assembly, the anterior section is separated from the posterior section. The lens 10 is adhered to the anterior section 22 thereby forming a device-in-mold assembly 30. As seen in FIG. 3, the device-in-mold assembly is then retained in a tray 80 and treated in a supercritical fluid chamber 60.

Contact lens materials are formed from the polymerization product of a mixture of monomers or prepolymers. (For purposes of convenience, the term “monomer” as used hereafter shall include prepolymers.) The monomeric mixture can also include materials other than monomers that aid in the polymerization process, such as a solvent or a diluent. Contact lens materials include materials for “hard” and “soft” lenses. The hard lens classification typically includes lenses such as rigid gas permeable (RGP) contact lenses, which are generally formed of crosslinked silicone acrylate or fluorosilicone acrylate copolymers. Soft lenses include “soft” hydrogel contact lenses. Hydrogels are hydrophilic polymers that absorb water to an equilibrium value and are insoluble in water due to the presence of a crosslinked three-dimensional network. Hydrogels are generally formed of a copolymer of at least one hydrophilic monomer and a crosslinking monomer. In the case of silicone hydrogel contact lenses, the copolymeric material further includes a silicone-containing monomer. Lenses in this class are generally formed of a copolymer of at least one hydrophilic monomer and a crosslinking monomer. Hydrophilic monomers include: unsaturated carboxylic acids, such as methacrylic acid and acrylic acid; (meth)acrylic substituted alcohols or glycols, such as 2-hydroxyethylmethacrylate, 2-hydroxyethylacrylate, glyceryl methacrylate, and polyethyleneglycol methacrylate; vinyl lactams, such as N-vinyl-2-pyrrolidone; and acrylamides, such as methacrylamide and N,N-dimethylacrylamide. Further examples of such hydrophilic monomers can be found in U.S. Pat. Nos. 4,153,641; 4,740,533; 5,034,461; and 5,070,215.

The crosslinking monomer can be a material having multiple polymerizable functionalities, preferably vinyl functionalities. Representative crosslinking monomers include: divinylbenzene; allyl methacrylate; ethyleneglycol di(meth)acrylate, tetraethyleneglycol di(meth)acrylate, polyethyleneglycol di(meth)acrylate; and vinylcarbonate derivatives of the glycol di(meth)acrylates. In the case of silicone hydrogel contact lenses, the copolymeric material further includes at least one silicone-containing monomer.

Suitable hydrogels are oxygen transporting, hydrolytically stable, biologically inert, and transparent. The monomers and copolymers are readily polymerized to form three dimensional networks which permit the transport of oxygen and are optically clear, strong and hydrophilic.

Referring to FIG. 1, in one configuration, a dose of the monomer is disposed within the mold assembly 20. Typically, the anterior section 22 includes a concave lens defining surface 24 (optical surface defining mold surface) and the posterior section 26 is convex and includes a convex lens forming surface 28. Polyvinyl chloride and polypropylene are satisfactory mold materials with polypropylene being particularly suitable.

The anterior section 22 is operably engaged with the posterior section 26 and the mold assembly 20 is then passed through a curing station (not shown), such as a curing tunnel to induce polymerization of the monomers.

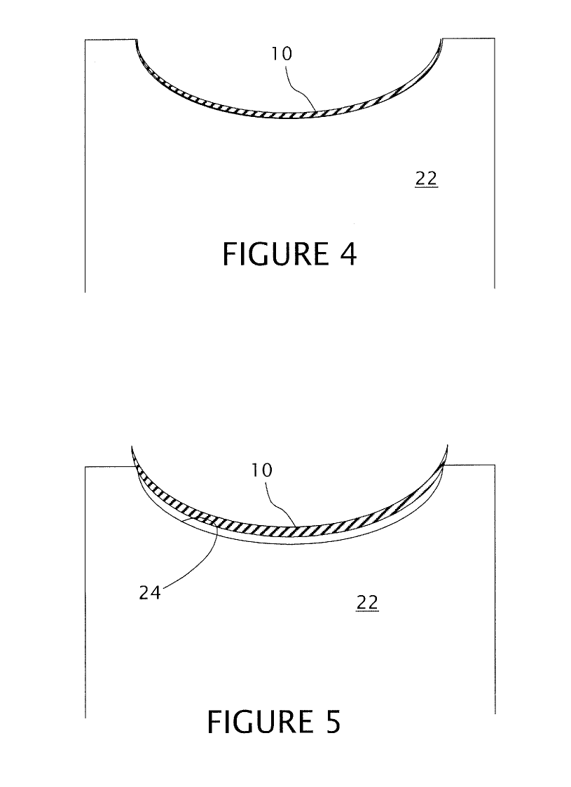

After passing through the curing station, the mold assembly 20 is separated. In one configuration, the posterior section 26 is removed from the anterior section 22, and a preferential release of the formed lens 10 occurs such that the lens remains adhered to the anterior section, thus forming the device-in-mold assembly 30. The mold assembly 20 is thus “decapped.” Referring to FIG. 4, the device-in-mold assembly 30 is in a molded configuration in that the lens 10 is adhered to the anterior section 22.

Generally, in the manufacture of contact lenses, some of the monomer is not fully polymerized. The incompletely polymerized material from the polymerization process can affect optical clarity or may be irritating to the eye. Residual material can include solvents or unreacted monomers, or oligomers present as by-products from the polymerization process.

The residual material can be hydrophilic or hydrophobic. Conventional methods to extract such residual materials from the polymerized contact lens material include extraction with water (for extraction of hydrophilic residual material) or an alcohol solution (for extraction of hydrophobic residual material). However, some of the alcohol extraction solution remains in the polymeric network of the polymerized contact lens material, and must itself, also be extracted from the lens material. This requires an additional extraction of the alcohol from the lens, generally using heated water for up to 4 hours or more.

The incomplete extraction of residual material from contact lenses may contribute adversely to the useful life of the lens. It is thought that some residuals may not be fully extracted and can, over time, migrate through the polymeric network of the lens toward the surface. The residuals may impact lens performance and comfort by interfering with optical clarity or the desired uniform hydrophilicity of the contact lens surface.

As set forth in U.S. Pat. No. 6,071,439 (hereby expressly incorporated by reference), it has been found that subjecting the contact lens to a supercritical fluid can extract residuals from the contact lens.

The supercritical fluid is provided in a supercritical fluid chamber 60 which is a pressurizeable and temperature controllable container into which a predetermined gas, vapor mixture or liquid can be introduced to form a supercritical fluid. The necessary controls and inputs for maintaining a supercritical fluid within the chamber are well known in the art and generally shown as a controller. Referring to FIG. 3, the supercritical fluid chamber 60 has at least one port 62 for introducing a fluid or gas into the chamber. The supercritical fluid chamber 60 can also include venting, pressurizing or outlet port 66. In addition, the supercritical chamber 60 allows for the loading and unloading of at least one tray 80. For example, the supercritical fluid chamber 60 can include a loading/unloading port or door 64, or can be formed of separable portions which allow the manual or automated loading and unloading of the trays 80.

In the supercritical fluid process, a gas is considered to be in a supercritical state when it is subjected to such a combination of pressure and temperature that its density approaches that of a liquid (where a liquid and gas state coexist). When a gas is subjected to such conditions, it is called a supercritical fluid. Exposing a contact lens to supercritical carbon dioxide (CO₂) produces a contact lens with enhanced optical clarity. Supercritical fluids can extract the unreacted or incompletely polymerized material in the polymeric structure of various contact lens materials.

Carbon dioxide is a preferred candidate for supercriticality since its critical temperature is 31° C. The critical temperature of a gas is the temperature at which a change in phase takes place causing an appreciable change in the physical properties of the gas. While present description is based upon CO₂, it is understood that many other gases under supercritical conditions can be used to treat contact lens polymeric materials, including supercritical nitrous oxide (N₂O), ethane as well as propane, or combinations thereof.

The solubility of a particular solid in a supercritical fluid depends upon the density and polarity of the supercritical fluid. Therefore, when a supercritical fluid is to be used to extract a particular component from a material, the specific solubility of the component must be experimentally determined.

For the extraction of incompletely polymerized residual material from contact lens materials, the CO₂ should be pressurized to from about 1000 psi to about 4000 psi, and is preferably from about 2000 psi to about 4000 psi when the temperature is kept within the range of from about 40° C. to about 90° C., and preferably from about 50° C. to about 80° C.

In addition to the extraction of residuals, the formed lens 10 must be released from the device-in-mold assembly 30. Both wet and dry release methods of lens release have been proposed in the prior art. In wet lens release methods, an aqueous solution is used to wet the hydrophilic lens which absorbs water and swells, causing the lens to separate from the mold surface. In dry release methods, the lens is removed from the associated mold surface while still in the dry state. The adhesive bond between the lens and mold surface is broken, usually by application of a force to the mold body, for example by squeezing or pressing against the non-optical surface of the mold to move the mold surface relative to the rigid lens. Once the adhesive bond has been broken, the lens is retrieved, for example by a vacuum picking tool.

As provided in the present invention, release of the lens 10 from the mold assembly 20 can be accomplished by exposure of the device-in-mold assembly 30 to a supercritical fluid. Supercritical fluid exposure to the device-in-mold assembly 30 can be used to release any type of contact lens 10 from mold sections made of any material. As seen in FIGS. 4 and 5, in the release of the lens 10, the lens transitions from a substantially contiguous contact with the mold surface 24 in a concave configuration to a discontinuous contact with the mold surface while remaining in a concave configuration. Thus, the device-in-mold assembly 30 can exhibit a first height in the molded (unreleased) state and a greater second height in the released state. It is advantageous to avoid unintended contact or interference with the device-in-mold assembly 30 in the released state.

Following release of the lens from the mold (or the mold section), the lens is hydrated with water or buffered saline. Subsequently, the lens is sterilized such as by autoclaving in water or saline.

The present invention specifically contemplates a tray 80 for the presentation and operable location of a plurality of ophthalmic device-in-mold assemblies 30 within the supercritical fluid chamber 60.

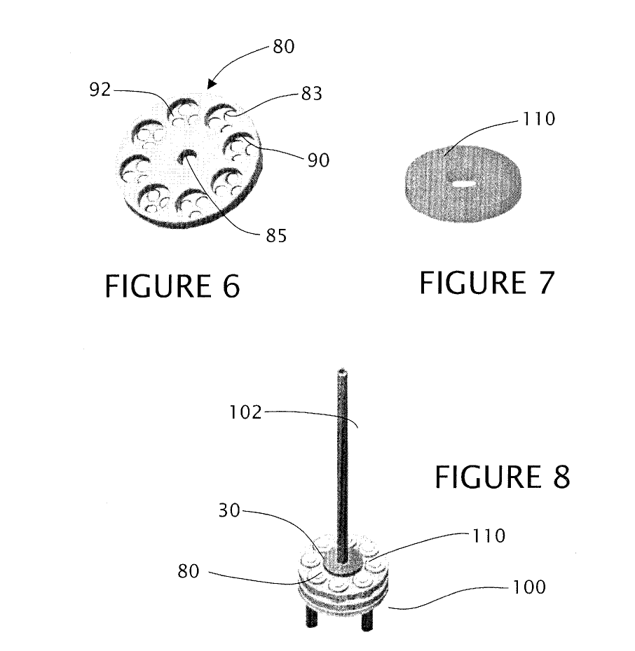

As seen in FIG. 6, the tray 80 includes a plurality of sockets 90 sized to receive the device-in-mold assemblies, and particularly, the anterior section (with the attached polymerized lens). Within each tray 80, the sockets 90 are located in an array or pattern. Any of a variety of socket arrays can be employed. The sizing and periphery of the sockets 90 relative to the mold sections to be received can vary and are at least partially determined by the presence of through passages 83 in the trays. The tray 80 can include through passages 83 to provide sufficient exposure to and maintenance of the desired environment within the supercritical fluid chamber 60. That is, the through passages 83 are selected to enhance a substantially homogeneous environment within the supercritical fluid chamber 60. Thus, sufficient flow can occur through and around the trays 80 to avoid localized anomalies.

Although the sockets 90 can be configured to receive an entire height of the anterior section 22, the sockets are sized such that a portion of the anterior section projects or extends above an adjacent portion of the tray 80 as shown in FIG. 3. This projecting portion of the anterior section 22 can be employed in an automated removal process of the device-in-mold assembly 30 from the tray 80. Thus, referring to FIG. 6, the socket 90 can include a shoulder or step 92 located to set off the mold section. Alternatively, the socket 90 can have a closed end which causes a portion of the mold section to extend above the adjacent surface of the tray 80.

As seen in FIG. 6, the sockets 90 can incorporate the through passages 83. Such sockets 90 have the shoulder 92 for locating the mold relative to the tray 80, and the through passage 83 extends from the socket to an opposing side of the tray. In this construction, a periphery of the socket 90 is greater than a periphery of the mold section so as to define a gap or annulus. The gap is exposed to the through passage 83, and thus flow through the tray 80 is provided. Referring to FIG. 6, a plurality of through passages 83 can intersect a given socket 90. It is also understood, the through passages 83 can be located outside the periphery of the socket 90.

The tray 80 can be formed from any of a variety of materials such as thermoplastics or thermosets. Satisfactory materials include polytetrafluoroethylene (Teflon®) or polyacetal resins (such as Delrin®). Preferably, the tray material is inert with respect to the anticipated environment within the supercritical fluid chamber 60, as well as the material of the mold assembly. The trays 80 can be formed by any of a variety of processes including molding or machining.

In one configuration, a plurality of trays 80 is employed, wherein each of the plurality of trays can operably retain and locate a plurality of device-in-mold assemblies 30. Although the plurality of trays 80 can be arranged in any of a variety of orientations, in one configuration shown in FIG. 8, a base 100 includes a projecting spindle 102, and the trays include an aperture 85 for passing a portion of the spindle there through. The plurality of trays 80 can thereby cooperatively engage the spindle 102.

To accommodate transformation of a device-in-mold assembly 30 from the molded configuration to the released configuration and to enhance circulation of the supercritical fluid and contact with the lens 10, spacing is provided between adjacent trays 80 within the supercritical fluid chamber 60. As disposed on the spindle 102, the spacing is a vertical separation between an upper portion of a device-in-mold assembly 30 on a lower tray and a bottom surface of an upper tray.

The spacing is provided by a spacing mechanism. The spacing mechanism can take the form of a washer 110. As seen in the figures, the washer 110 is sized to receive a portion of the spindle 102 there through. An outer diameter or dimension of the washer 110 is sized to be disposed within the array of sockets 90 so that flow through the trays 80 is not adversely affected. In one configuration, the washer 110 has a sufficient thickness (dimension in the vertical axis) to allow transitioning of the device-in-mold assembly 30 from the molded configuration to the released configuration without contacting the released lens 10 with an overlaying tray.

As seen in FIG. 3, the spacer mechanism can be configured as a plurality of bumps, ridges or feet 120 projecting from an upper or lower surface of a given tray 80, wherein the ridges contact an adjacent tray and thereby define a separation distance. The projections of adjacent trays can be cooperatively configured to allow stable stacking. The projections 120 can cooperate with seats or recesses in an adjacent tray to provide the necessary spacing between adjacent trays.

The present invention can be employed in the contact lens forming process, wherein upstream processing steps include introducing a dose of the monomer mixture within the anterior section 22, and operably engaging the posterior section 26 with the anterior section. The mold assembly 20 is then passed through the curing station thereby forming the lens. After passing through the curing station, the mold assembly 20 is decapped to provide the device-in-mold assembly 30.

A plurality of the device-in-mold assemblies 30 are disposed within corresponding sockets 90 in the tray 80. The device-in-mold assemblies 30 can be located in the tray 80 by any of a variety of mechanisms including manual or automated loading. The tray 80 and retained device-in-mold assemblies 30 are then disposed within the supercritical fluid chamber 60. It is understood, if a plurality of trays 80 are employed with the spindle 102, a stack of loaded trays are formed upon the spindle, and the spindle and trays can then be disposed within the supercritical fluid chamber 60. Further, the spacing mechanism is employed to accommodate for transition of the device-in-mold assemblies 30 from the molded configuration to the released configuration. For example, the washer 110 creates a sufficient distance between the adjacent trays to permit the ophthalmic device-in-mold assembly 30 to transition from a molded configuration to a released configuration without inducing contact of the lens 10 and a tray 80. Further, the washer 110 reduces flow restrictions of the supercritical fluid between adjacent trays 80, thereby enhancing contact of the supercritical fluid and the lens 10. In the configuration employing trays with projections 120, the trays 80 can be stacked and introduced into the supercritical third chamber 60 or can be individually located into the chamber to form the stack within the chamber.

The supercritical fluid chamber 60 is then operated to expose the device-in-mold assemblies 30 to the desired environment. The supercritical fluid permeates the supercritical fluid chamber 60 and passes along through passages 83 in the tray 80, thereby enhancing exposure to the lens 10.

During the extraction process and release process, the device-in-mold assemblies 30 transition from the molded configuration to the released configuration, where a spacing is generated between the lens and the anterior mold, such that the lens is readily separable from the mold.

By accommodating the device-in-mold assembly 30, the present system allows for both the extraction process and the release process to occur within the supercritical fluid chamber 60, thereby increasing efficiencies.

Although the present description is set forth in terms of contact lenses, it is understood the present invention may further assist in the manufacture of materials which can be used for biomedical devices, such as, surgical devices, heart valves, vessel substitutes, intrauterine devices, membranes and other films, diaphragms, surgical implants, blood vessels, artificial ureters, artificial breast tissue and membranes intended to come into contact with body fluid outside of the body, e.g., membranes for kidney dialysis and heart/lung machines and the like, catheters, mouth guards, denture liners and intraocular devices.

Many other modifications and variations of the present invention are possible to the skilled practitioner in the field in light of the teachings herein. It is therefore understood that, within the scope of the claims, the present invention can be practiced other than as herein specifically described.

What is claimed is:

1. A method of treating an ophthalmic device-in-mold assembly, the method comprising:
(a) retaining the ophthalmic device-in-mold assembly on a tray; and
(b) disposing the tray and the retained ophthalmic device-in-mold assembly in a supercritical fluid treatment chamber.

2. The method of claim 1, further comprising disposing a plurality of trays in the supercritical fluid treatment chamber.

3. The method of claim 2, further comprising spacing the trays a sufficient distance to permit the device-in-mold assembly transitioning from a molded configuration to a released configuration.

4. The method of claim 1, further comprising filling the supercritical fluid treatment chamber with a supercritical fluid.

5. The method of claim 1, further comprising passing a supercritical fluid through apertures in the tray.

6. The method of claim 1, further comprising retaining a plurality of ophthalmic device-in-mold assemblies on the tray.

7. The method of claim 1, further comprising configuring the ophthalmic device-in-mold assembly to include only a single optical surface forming mold surface.

8. A method of treating an ophthalmic device-in-mold assembly, comprising locating the ophthalmic device-in-mold assembly on a tray in a supercritical fluid treatment chamber.

9. The method of claim 8, further comprising retaining a plurality of ophthalmic device-in-mold assemblies on the tray.

10. The method of claim 8, further comprising disposing a plurality of trays in the supercritical fluid treatment chamber.

11. The method of claim 10, further comprising spacing adjacent trays in the supercritical fluid treatment chamber by a sufficient distance to permit the ophthalmic device-in-mold assembly transitioning from a molded configuration to a released configuration.

12. In a method for forming an ophthalmic device, the step of locating an ophthalmic device-in-mold assembly within a supercritical fluid chamber to cause separation of the ophthalmic device from a molding surface.

13. A system for treating ophthalmic device-in-mold assembly, the system comprising:
(a) a supercritical fluid chamber; and
(b) a tray sized to be retained within the supercritical fluid chamber, the tray supporting an ophthalmic device-in-mold assembly within the supercritical fluid chamber.

14. The system of claim 13, further comprising a plurality of trays in the supercritical fluid chamber, each tray supporting at least one ophthalmic device-in-mold assembly.

15. The system of claim 14, further comprising a spacer intermediate at least two of the plurality of trays, the spacer separating the two trays by a distance sufficient to allow unobstructed movement of an ophthalmic device-in-mold assembly from a molded configuration to a released configuration.

16. An apparatus for treating an ophthalmic device-in-mold assembly, the apparatus comprising:
(a) a supercritical fluid chamber;
(b) a tray within the supercritical fluid chamber, the tray having at least one retaining socket; and
(c) an ophthalmic device-in-mold assembly at least partially retained within the socket.

17. The apparatus of claim 16, wherein the ophthalmic device-in-mold assembly includes a lens defining surface.

18. The apparatus of claim 16, wherein the ophthalmic device-in-mold assembly includes only a single lens defining surface.

19. The apparatus of claim 16, wherein the tray includes a plurality of retaining sockets.

20. The apparatus of claim 16, wherein the ophthalmic device-in-mold assembly projects from an adjacent surface of the tray.

21. The apparatus of claim 16, further comprising a plurality of trays in the supercritical fluid chamber.

22. The apparatus of claim 21, wherein each of the trays includes a plurality of retaining sockets.

23. The apparatus of claim 21, further comprising a spacer intermediate two adjacent trays in the supercritical fluid chamber.

24. The apparatus of claim 23, wherein the spacer creates a sufficient distance between the adjacent trays to permit the ophthalmic device-in-mold assembly to transition from a molded configuration to a released configuration.
